(19) United States
(12) Patent Application Publication
(10) Pub. No.: US 2022/0150585 A1
(43) Pub. Date: May 12, 2022

(54) DEVICE AND METHOD FOR ENCODING CONTENT

(71) Applicant: INSOFT, Seongnam-si, Gyeonggi-do (KR)

(72) Inventors: Taehyun KIM, Yongin-si, Gyeonggi-do (KR); Young Whan LEE, Seodaemun-Gu, Seoul (KR)

(21) Appl. No.: 17/418,506

(22) PCT Filed: Dec. 28, 2018
(86) PCT No.: PCT/KR2018/016887

§ 371 Date: Jun. 25, 2021

(30) Foreign Application Priority Data
Dec. 27, 2018 (KR) 10-2018-0171355

(51) Int. Cl. H04N 21/4402; H04N 19/154; H04N 19/184; H04N 19/119

(52) U.S. Cl. CPC H04N 21/440245; H04N 19/119; H04N 19/184; H04N 19/154

(57) ABSTRACT

An encoding method of an encoding apparatus, which is performed by a computing device includes: generating an encoder control signal to encode video contents into a plurality of intermediate streams having different resolutions and having a range of the same encoding quality parameter value; and generating a control signal to configure a plurality of final streams based on segments of each intermediate stream, which have a range of the same bitrate value, in which the intermediate stream and the final steam include at least one segment.

### CROSS-REFERENCE TO RELATED APPLICATION

This application claims priority to and the benefit of Korean Patent Application No. 10-2018-0171355 filed in the Korean Intellectual Property Office on Dec. 27, 2018, the entire contents of which are incorporated herein by reference.

### BACKGROUND OF THE DISCLOSURE

### Field of the Disclosure

The present disclosure relates to an apparatus, a system, and a method for encoding content data, and more particularly, to a technology of encoding an adaptive bitrate (ABR) scheme stream.

### Related Art

Many users are using services that download and reproduce large media contents such as moving picture, etc., through a wired/wireless network in a user terminal such as a mobile terminal, a computer, etc., and a content provider makes efforts to provide seamless services of content data transmission for user satisfaction.

The content provider can transmit content data to the user terminal through a replication server (may be referred to as a cache server, a ghost server, an edge server, or a mirror server0 of a content delivery network (CDN) service. That is, as one of methods for transmitting the content data, there is a method in which the content provider prestores at least some contents in the replication server and the user and the user terminal receives the prestored content data from the replication server. In this case, the user terminal can receive the content data from the corresponding CDN replication server in a streaming scheme or download scheme.

In order to provide the seamless service of the content data transmission, contents can be encoded into a plurality of streams (may be referred to as rendition) having different bitrates and stored in the replication server, and the user terminal can request transmission of a stream considering a network environment thereof, and this is referred to as adaptive bitrate (ABR) stream transmission.

### SUMMARY

In related art that encodes contents for adaptive bitrate (ABR) scheme stream transmission, there is a problem in that when content data is encoded into a plurality of streams having different bitrates, only the bitrate is emphasized by considering only a network situation, and as a result, an image quality of contents felt by a user deteriorates.

Accordingly, an encoding apparatus and a method thereof which encode contents into ABR streams suitable for the network situation without deterioration of the image quality felt by the user are required.

In an aspect, disclosed is an encoding method of an encoding apparatus. The encoding method of an encoding apparatus, which is performed by a computing device may include: generating an encoder control signal to encode video contents into a plurality of intermediate streams having different resolutions and having a range of the same encoding quality parameter value; and generating a control signal to configure a plurality of final streams based on segments of each intermediate stream, which have a range of the same bitrate value, in which the intermediate stream and the final steam may include at least one segment.

In another aspect, disclosed is an encoding apparatus. The encoding apparatus may include: a storage unit storing at least any one of video contents, a control variable for generating an encoder control signal, and intermediate data generated during an encoding process; a control unit generating an encoder control signal to encode the video contents into a plurality of intermediate streams having different resolutions and a range of the same encoding quality parameter value, and generating a control signal to configure a plurality of final streams based on segments of each intermediate stream, which have a range of the same bitrate value; and a communication unit receiving the video contents or transmitting at least any one final stream of the final streams, in which the intermediate stream and the final steam include at least one segment.

According to embodiments disclosed in the present disclosure, an adaptive bitrate (ABR) encoding technology of generating a stream suitable for a network situation of a user terminal can be provided.

According to embodiments disclosed in the present disclosure, an adaptive bitrate (ABR) encoding technology without deterioration of an image quality felt by a user can be provided.

### BRIEF DESCRIPTION OF THE DRAWINGS

FIG. 1 schematically illustrates an embodiment including a content encoding apparatus.

FIG. 2 schematically illustrates an embodiment including a content encoding apparatus.

FIGS. 3 and 4 schematically illustrate configurations of content encoding apparatuses.

FIG. 5 schematically illustrates an encoding operation method of a content encoding apparatus.

FIG. 6 illustrates an embodiment of encoded intermediate streams.

FIG. 7 illustrates an embodiment of final streams.

FIG. 8 schematically illustrates another encoding operation method of a content encoding apparatus.

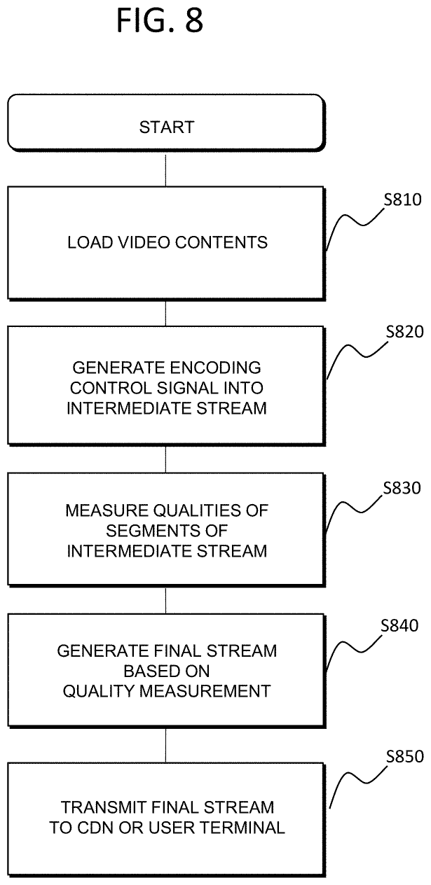

FIG. 9 illustrates another embodiment of an encoding operation method.

### DESCRIPTION OF EXEMPLARY EMBODIMENTS

A technology disclosed in the present disclosure may be applied to a content encoding apparatus. However, the technology disclosed in the present disclosure is not limited thereto, but may be applied even to all electronic devices and methods applicable to a technical spirit of the technology.

It is noted that technical terms used in the present disclosure are used to just describe a specific embodiment and do not intend to limit the spirit of the technology disclosed in the present disclosure. Further, unless the technical terms used in the present disclosure are particularly defined as other meanings in the present disclosure, the technical terms should be appreciated as meanings generally appreciated by those skilled in the art in a field to which the technology disclosed in the present disclosure pertains and should not be appreciated as excessively comprehensive meanings or excessively reduced meanings. Further, when the technical term used in the present disclosure is a wrong technical term that cannot accurately express the spirit of the technology disclosed in the present disclosure, the technical term is substituted by a technical term which can correctly appreciated by those skilled in the art in the field to which the technology disclosed in the present disclosure pertains to be appreciated. In addition, a general term used in the present disclosure should be interpreted as defined in a dictionary or contextually, and should not be interpreted as an excessively reduced meaning.

Terms including ordinal numbers, such as first, second, etc., used in the present disclosure can be used to describe various components, but the components should not be limited by the terms. The terms are used only to discriminate one component from another component. For example, a first component may be named as a second component and similarly, the second component may also be named as the first component without departing from the scope of the present disclosure.

Hereinafter, embodiments disclosed in the present disclosure will be described in detail with reference to the accompanying drawings and the same or similar components are denoted by the same reference numerals regardless of a sign of the drawing, and duplicated description thereof will be omitted.

Further, in describing the technology disclosed in the present disclosure, a detailed description of related known technologies will be omitted if it is determined that the detailed description makes the gist of the technology of the present disclosure unclear. Further, it is noted that the accompanying drawings are used just for easily appreciating the spirit of the technology of the present disclosure and it should not be analyzed that the spirit of the technology is limited by the accompanying drawings.

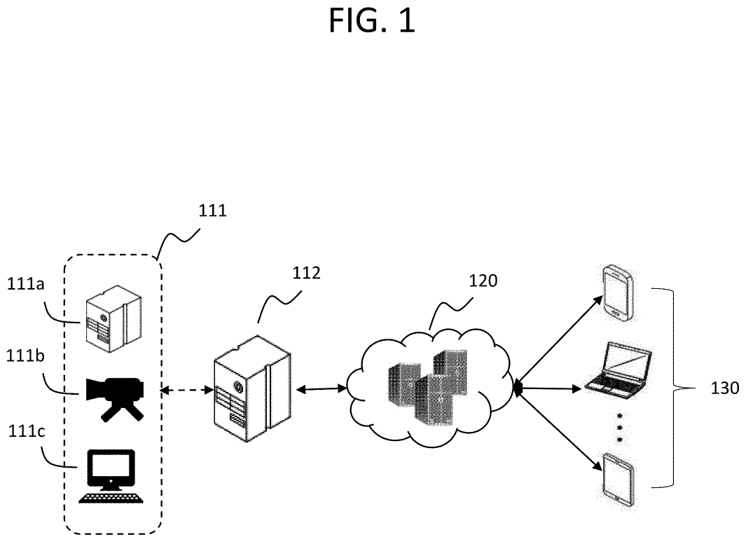

FIG. 1 schematically illustrates an embodiment including a content encoding apparatus 112. The content encoding apparatus 112 may be connected to a content delivery network 120 and a user terminal 130 through a wired or wireless network.

The content encoding apparatus 112 may receive original contents (a mezzanine file) and encode the received original contents into a stream (bitstream) or package the encoded stream in an embodiment. In an embodiment, the content encoding apparatus 112 may receive a content transmission request from the user terminal 130 and transmit a manifest file for corresponding content transmission to the user terminal 130, and the content encoding apparatus may be referred to as an origin server or a packaging apparatus.

In another example, in addition to the content encoding apparatus 112, an apparatus (not illustrated) that packages the encoded stream according to a transmission protocol or an origin server (not illustrated) receiving the content transmission request and transmitting the manifest file may be separately provided.

The CDN 120 may have a hierarchical structure constituted by caching nodes for storing and transmitting copies of contents, and include an edge server (a cache server, a ghost server, an edge server, or a mirror server) transmitting the contents to high tier caching nodes and the user terminal in the hierarchical structure.

In FIG. 1, it is not excluded that the content encoding apparatus 112 operates as one apparatus of the CDN 120.

The stream encoded by the content encoding apparatus 112 may be transmitted to the CDN edge server and distributed to the user terminal 130 in a Real Time Transport Protocol/Real Time Streaming Protocol (RTP/RTSP), Real Time Message Protocol (RTMP), or hypertext transfer protocol (HTTP) scheme, and the user terminal may periodically request the manifest file in order to secure a content list requestable to the content encoding apparatus, the origin server, or a separate CDN apparatus.

In another embodiment, the content encoding apparatus 112 may receive a live stream such as sport broadcasting, concert live broadcasting, etc., pre-recorded contents such as a TV program, a movie, etc., or advertisement contents, and encode or package the same.

In an embodiment, the content encoding apparatus 112 may receive a content data file from a separate content data providing apparatus 111 and encode the received content data file, and the content data providing apparatus 111 may be a content data storage server 111a, broadcasting equipment 111b, or a content data production computing device 111c, and if the content encoding apparatus 112 may transmit or provide the content data, the type thereof is not particularly limited.

The content encoding apparatus 112 may encode or encode and package contents into a plurality of streams (bitstreams or renditions) having different bitrates, and transmit the contents to the CDN 120.

A stream set or any one stream obtained by encoding or packaging the contents based on various settings or environments may be referred to as the rendition.

The plurality of streams having different bitrates may include a stream encoded at a high bitrate and a stream encoded at a low bitrate, and the number of final streams included in the rendition is not particularly limited.

The content encoding apparatus 112 may simultaneously encode or package the plurality of streams for the contents, and transmit the streams to the CDN apparatus or encode or package and transmit any one stream of the plurality of streams according to the request from the CDN apparatus.

Each stream in which the content data is encoded may include at least one segment which may be referred to as a chunk), and each segment may include at least one group of pictures (GOP).

The segment represents a part of the stream in which the content data is encoded and each segment may be decoded or reproduced in the user terminal 130 or stored in the user terminal (temporarily or during a predetermined period).

The content encoding apparatus 112 or a separate origin server (not illustrated) may generate a manifest file for a plurality of renditions or receive the generated manifest file and transmit the received manifest file to the CDN apparatus.

In another embodiment, the corresponding manifest file may be generated or provided by the high tier caching node in the CDN 120.

The manifest file may include an access (request) route of the segment of the content stream requestable by the user terminal 130 or other related data or related metadata.

As an embodiment, when there is the plurality of streams having different bitrates for the same contents and the user terminal 130 is capable of all streams, the content encoding apparatus, the origin server, or the high tier caching node may generate the manifest file including the access route capable of requesting the plurality of streams. In an embodiment, when the content encoding apparatus generates the manifest file, the origin server or the high tier caching node of the CDN may receive the manifest file.

In an embodiment, the manifest file generated or provided by the content encoding apparatus 112 may be based on the plurality of streams having different bitrates, each stream may be constituted by a plurality of segments, and some of segments of any one stream may have different resolutions or the same encoding quality parameter value (or range of the encoding quality parameter). This will be described below in detail.

The CDN 120 may mean a system constituted by a network of computing devices (e.g., servers), each computing device of the CDN 120 may be referred to as a node, and the CDN 120 may store or transmit a bitstreamed stream of the contents (between respective nodes or to the user terminal).

The content encoding apparatus 112 may transmit, to the origin server or the CDN 120, the bitstreamed stream of the contents and the CDN 120 may transmit, between the respective nodes or to the user terminal 130, the bitstreamed stream of the contents, through a wideband network, the network may be, for example, a common network such as a wireless network, a wired network, or the Internet, a private network, a global system for mobile communication network (GSM), a general packet radio network (GPRS), a local area network (LAN), a wide area network (WAN), a metropolitan area network (MAN), a cellular network, a public switched telephone network (PSTN), a personal area network, Bluetooth, Wi-Fi Direct, near field communication, an UltraWide band, a combination thereof, or random other networks, but is not limited thereto.

The user terminal 130 may receive content access information for a content providing request of the user terminal 130 from the content encoding apparatus 112, the origin server, or a separate apparatus (a DNS server, a content server, or a manifest server of the CDN) through the network, and make a content transmission request to the edge server according to the corresponding access information.

The user terminal of the embodiment disclosed in the present disclosure may include a table computer, a smartphone, etc., in addition to a personal computer (PC).

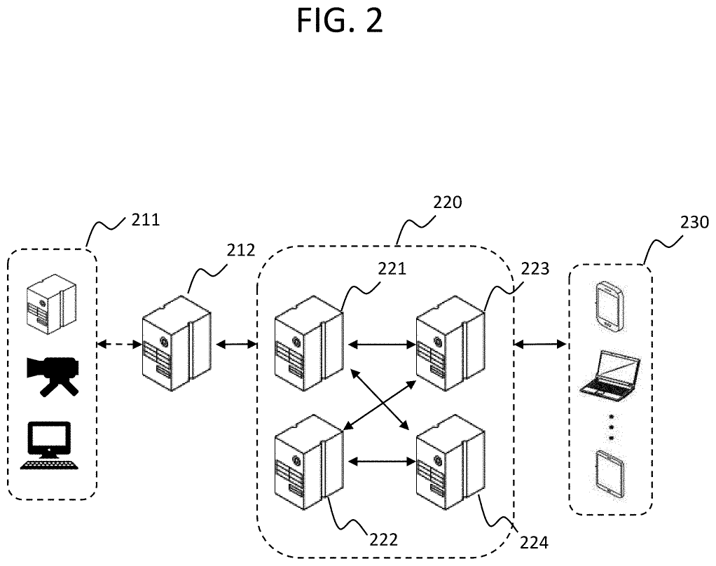

FIG. 2 schematically illustrates an embodiment including a content encoding apparatus 212. In FIG. 2, it is illustrated that the content encoding apparatus 21 exists outside the CDN, but it is not excluded that the content encoding apparatus 212 operates as one apparatus of a CDN 220.

As an embodiment, the content encoding apparatus 212 may operate as an active stream server, and a request for the content data from a user terminal 230 may be transmitted to the content encoding apparatus 212 via the CDN 220 or directly, and the request may be based on a protocol based on RTP/RTSP, RTMP, or HTTP.

As an embodiment, the content encoding apparatus 212 may transmit the bitstreamed stream of the contents and the manifest file, according to a request from the origin server (not illustrated), or mid-tier caching nodes 221 and 222 or edge servers 223 and 224 of the CDN 220 or in advance when contents are first distributed, to the mid-tier caching nodes 221 and 222 or the edge servers 223 and 224, and this may vary depending on a policy of a CDN service.

The mid-tier caching nodes 221 and 222 or the edge servers 223 and 224 request and receives all of a plurality of streams or any one stream for the contents to and from a high tier caching node, the origin server, or the content encoding apparatus 212 at a content request or a request for any one stream of the contents from a user terminal 230, and then store the all streams or any one stream in a local storage unit.

In this case, the plurality of streams may have the same encoding quality parameter value (or range of the encoding quality parameter value). Further, each stream of the plurality of streams may include a plurality of segments, and each stream may include a plurality of segments having different resolutions.

Accordingly, even when the user terminal receives a plurality of segments of a stream having the same bitrate, the user terminal receives segments which have different resolutions, but the same encoding quality parameter value (or range thereof), so even when characteristics of an image are changed, the user terminal may receive contents which are low in deterioration of the image quality felt by the user. The reason is that the feeding of the user for the contents is more sensitive to the image quality represented by the encoding quality parameter value than the resolution.

The encoding quality parameter as a parameter which influences the image quality of the image itself during encoding may be a quantization parameter (QP) and a rate factor (RF).

In an embodiment, when a content provider receives a query for an IP address for content providing through the content encoding apparatus 212, the origin server (not illustrated), or a name server (not illustrated), the content provider may re-direct the query to a CDN management server (not illustrated) or determine edge servers 223 and 224 which possess the corresponding contents by considering a situation of the user terminal 230 requested by the content encoding apparatus 212, the origin server (not illustrated) itself, or the CDN management server to which the query is re-directed, and provide a corresponding access route to the user terminal 230. Alternatively, the user terminal 230 may make a content providing request by accessing a prestored IP address of the CDN management server, and the CDN management server determines an appropriate edge server by considering the situation of the requested user terminal to inform the user terminal of the corresponding access route.

In another embodiment, when the content provider receives a request for content providing through the content encoding apparatus 212, the origin server (not illustrated), or the name server, the content provider may transmit the manifest file as a response, and the user terminal 230 may make a content providing request (stream providing request) to the edge server 223 and 224 based on a manifest file including access information to the plurality of streams having different bitrates of the same contents and according to access information of the manifest file for a stream having a suitable bitrate by considering a network situation of the user terminal 230.

A stream transmission scheme of the content data disclosed in the present disclosure may be, for example, the RTP/RTSTP or RTMP based protocol or the HTTP based protocol (for example, HTTP Live Streaming (HLS)/HDS, Smooth Streaming, Dynamic Streaming, MPEG Dynamic Adaptive Streaming over HTTP (DASH), etc.), but is not particularly limited to the method.

In an embodiment, the edge servers 223 and 224 or the mid-tier caching nodes 221 and 222 do not store the rendition of the contents requested from the user terminal 230, the edge servers 223 and 224 or the mid-tier caching nodes 221 and 222 may transmit a transmission request for any one stream of the contents to the content encoding apparatus 212, the origin server (not illustrated0, or the high tier caching node of the CDN, and the content encoding apparatus 212, the origin server (not illustrated), or the high tier caching node of the CDN may transmit the requested stream to the requesting CDN apparatuses 221 to 224.

The content encoding apparatus 212 and the origin server (not illustrated) may receive a transmission request for all of a plurality of streams or at least any one stream for specific contents from the CDN mid-tier caching nodes 221 and 222 or edge servers 223 and 224, and the content encoding apparatus 212 and the origin server (not illustrated) may transmit all of the plurality of streams or at least any one stream to the requesting CDN apparatuses 221 to 224.

In yet another embodiment, the plurality of streams having different bitrates of the same contents may be stored in different edge servers 223 and 224 for each stream.

As an embodiment, the user terminal 230 may be transmitted with the manifest file including the plurality of streams having different bitrates in response to the content request and transmitted with a high bitrate stream from a first edge server 223 when receiving an initial segment, and subsequently transmitted with a low bitrate stream from a second edge server 224 based on the network situation and the manifest file.

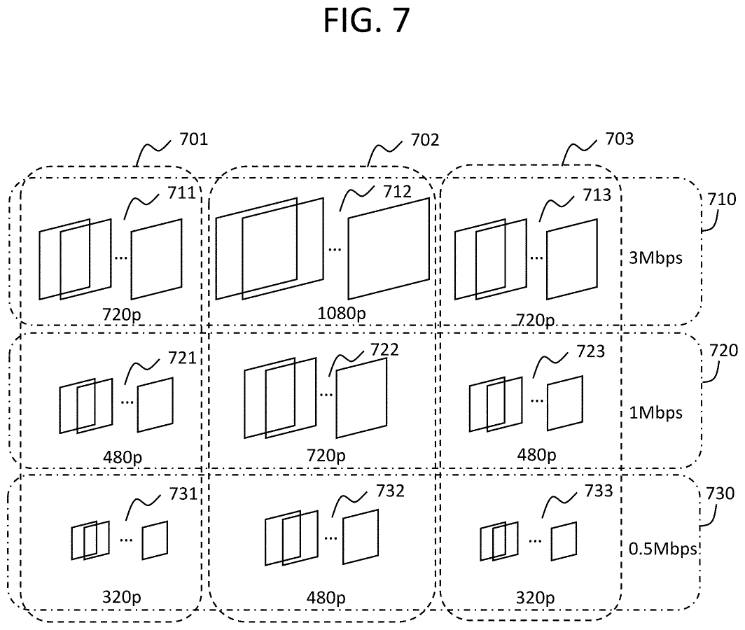

In this case, the high bitrate stream possessed by the first edge server 223 and the low bitrate stream possessed by the second edge server may have the same encoding quality parameter value (or range of the value) like final streams 710, 720, and 730 of FIG. 7 to be described below, and may be constituted by a plurality of different segments having different resolutions, respectively, like the final streams 710, 720, and 730 of FIG. 7.

The content encoding apparatus 212, the origin server (not illustrated), or the high tier CDN caching node may package an encoded bitstream with a packager, and make a manifest file suitable for a transmission protocol be included based on bitstreamed streams during packaging.

In this case, the content encoding apparatus 212, the origin server (not illustrated), or the high tier CDN caching node may encode or package original contents into the plurality of streams having different bitrates, each stream may be constituted by the plurality of segments having different resolutions, and the encoding quality parameter value (or the range of the value) of each stream may be equal to each other even though the stream is different.

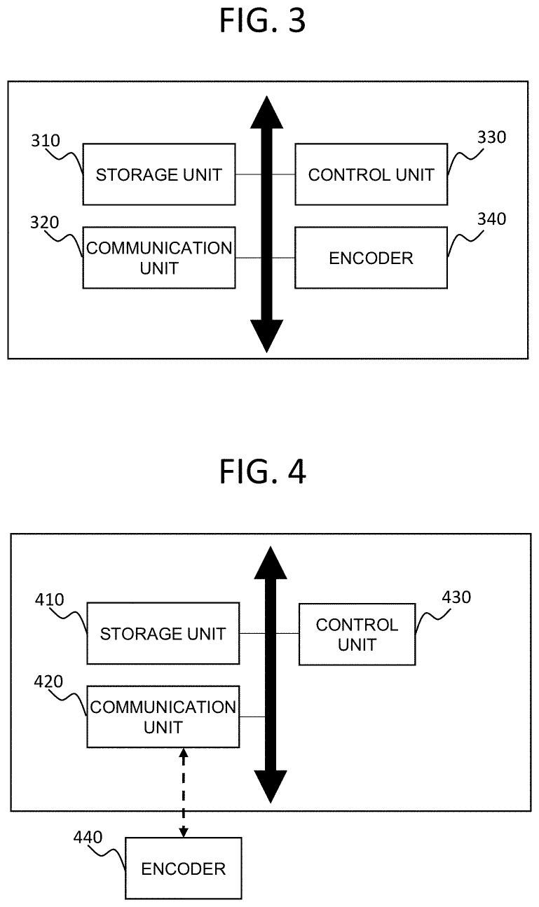

FIGS. 3 and 4 schematically illustrate configurations of the content encoding apparatuses 112 and 212.

The content encoding apparatuses 112 and 212 may include storage units 310 and 410 storing at least any one of original data used for encoding, intermediate data generated during encoding, or final result data of encoding.

The storage units 310 and 410 may include volatile memories such as magnetic storage media, flash storage media, a random access memory (RAM), etc., and may be transitory storage media or semi-persistent storage media, but the scope of the present disclosure is not limited thereto.

The content encoding apparatuses 112 and 212 may include communication units 320 and 420 that are transmitted with the content data from the content data providing apparatus or transmit an encoded result to the origin server or the CDN apparatus.

When the content encoding apparatuses 112 and 212 serve to respond to the content data transmission request from the user terminal, the communication units 320 and 420 may be transmitted with a content transmission request or a stream transmission request from the user terminal and transmit a response thereto.

Control units 330 and 430 may generate a control signal to control encoders 340 and 440 to encode the content data into a stream suitable for streaming.

In an embodiment, the control unit may generate a control signal to directly encode the content data into the plurality of streams having different bitrates or generate a control signal to encode the content data into a plurality of intermediate streams, and then encode the plurality of intermediate streams into the plurality of final streams having different bitrates, and the control signal includes a message type signal in addition to an electrical signal.

The encoders 340 and 440 which the control units 330 and 430 generates the control signal to control to perform encoding may be a chip type encoder 340 or a module type encoder 340 included in the content encoding apparatuses 112 and 212, and as another embodiment, the encoders 340 and 440 may exist as a separate encoding apparatus 440 outside the content encoding apparatuses 112 and 212.

When the encoder is the chip type encoder or the module type encoder 340 included in the content encoding apparatuses 112 and 212, the encoder may be an application-specific integrated circuit (ASIC) chip, field-programmable gate arrays (FPGAs), or a programmable-logic device itself or a part thereof, and the control unit 330 may be implemented in some other part.

In another embodiment, the encoder may be a part of a universal processor and the control unit may also some other part of the corresponding processor.

The control units 330 and 430 or the encoders 340 and 440 may be conventional universal processors. The control units 330 and 430 or the encoders 340 and 440 may be implemented as a microprocessor, a microcontroller, a reduced instruction set computer (RISC) processor, a complex instruction set computer (CISC) processor, a single instruction multiple data (SIMD) processor, a signal processor, a central processing unit (CPU), an arithmetic logic unit (ALU), a video digital signal processor (VDSP), application specific integrated circuits (ASICs), field programmable gate arrays (FPGAs), programmable logic devices (PLDs), complex programmable logic devices (CPLDs), radio frequency integrated circuits (RFICs), and application specific standard products (ASSPs).

When the control units 330 and 430 generate a control signal to control the encoder to encode the content data into a plurality of intermediate streams, and then encode the plurality of intermediate streams into a plurality of final streams having different bitrates, both the plurality of intermediate streams and the plurality of final streams may include at least one segment.

In an embodiment, the control units 330 and 430 may generate a control signal to control the encoder so as for all segments included in the plurality of intermediate streams and the plurality of final streams to have the same encoding quality parameter value.

In an embodiment, the control units 330 and 430 may generate a control signal to control the encoder so as for each final stream among the plurality of final streams to include a plurality of segments having different resolutions.

In an embodiment, the control units 330 and 430 may generate a control signal to control the encoder so as for segments of different intermediate streams among the plurality of intermediate streams to have different resolutions and segment of the same intermediate stream to have the same resolution.

In an embodiment, the control units 330 and 430 may generate a control signal to control the encoder so as for any one final stream among the plurality of final streams to include segments having different resolutions.

In an embodiment, the control units 330 and 430 may generate a control signal to perform quality measurement for the segments of the intermediate streams and configure the plurality of final streams based on a result of the quality measurement.

The quality measurement may adopt an image quality assessment method such as Peak Signal-to-noise ratio (PSNR), Structural Similarity Index (SSIM), Multi-scale Structural Similarity (MS-SSIM), or Video Multimethod Assessment Fusion (VMAF), and as a method for measuring the quality of the image, if results are capable of being compared with each other, the type of method is not particularly limited, and an operation of configuring the final stream based on the quality measurement result will be described below in detail.

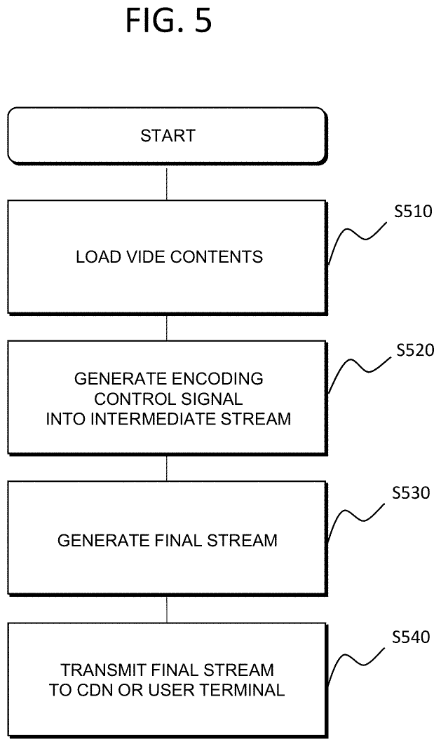

FIG. 5 schematically illustrates encoding operation methods of content encoding apparatuses 112 and 212.

The content encoding apparatuses 112 and 212 may provide or receive original contents (a mezzanine file), or load a live stream such as sport broadcasting, concert live broadcasting, etc., pre-recorded contents such as a TV program, a movie, etc., or advertisement contents in order to transmit or receive and encode the live stream, the pre-recorded contents or the advertisement contents (S510).

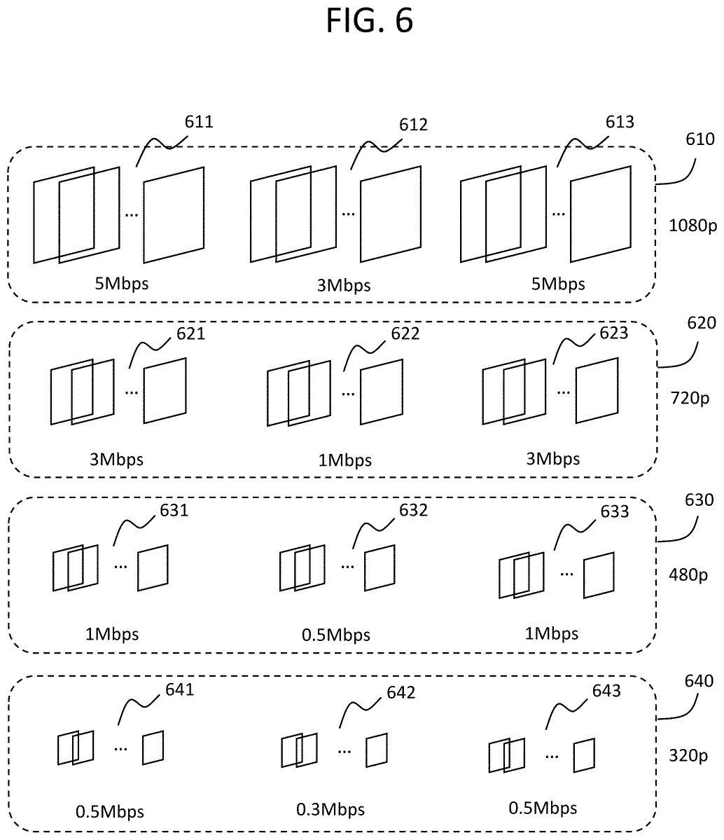

The content encoding apparatuses 112 and 212 may generate an encoder control signal to encode the content data into a plurality of intermediate streams illustrated in FIG. 6 (S520).

In an embodiment, the content encoding apparatuses 112 and 212 may generate an encoder control signal to encode intermediate streams of a number equal to or more than the number of final streams to be generated as a final result of encoding, and when the content encoding apparatuses 112 and 212 encode the content data into the intermediate stream, the content encoding apparatuses 112 and 212 may generate an encoder control signal to encode segments of different intermediate streams into intermediate streams having different resolutions.

For example, when generating the final stream as final streams having three different bitrates, the content encoding apparatuses 112 and 212 may generate an encoder control signal to encode the content data into 3, 4, or 5 or more intermediate streams, and FIG. 6 illustrates an embodiment of generating 4 intermediate streams in order to generate 3 final streams.

As another example, when 3 final streams are generated, 5 or 6 intermediate streams may be generated, and this may vary depending on a combination of the resolution of the intermediate stream and the number of encoding quality parameters.

For example, in order to generate final streams of a high stream having a bitrate of 4 Mbps, a medium stream having a bitrate of 1 Mbps, and a low stream having a bitrate of 0.5 Mbps, when the content encoding apparatus intends to use both QP and RF as encoding quality parameters with 4 resolutions, the content encoding apparatus may generate a control signal to encode the content data into a total of 8 intermediate streams including a stream having the same QP value with a first resolution, a stream having the same RF value with the first resolution, a stream having the same QP value with a second resolution, a stream having the same RF value with the second resolution, a stream having the same QP value with a third resolution, a stream having the same RF value with the third resolution, a stream having the same QP value with a fourth resolution, and a stream having the same RF value with the fourth resolution. In this case, the content encoding apparatus may generate a control signal to configure a final stream of a high stream having a bitrate of 4 Mbps, a medium stream having a bitrate of 1 Mbps, and a low stream having a bitrate of 0.5 Mbps from segments of a total of 8 intermediate streams.

Referring to FIG. 6, it is illustrated that as an embodiment of generating 4 intermediate streams, the content encoding apparatuses 112 and 212 generate, as 4 intermediate streams in which the encoding quality parameters of the QP value or RF value are the same as each other, a first intermediate stream 610 having a resolution of 1080p (for convenience, displays only a horizontal resolution of a frame included in the segment), a second intermediate stream 620 having of a resolution of 720p, a third intermediate stream 630 having a resolution of 480p, and a fourth intermediate stream 640 having a resolution of 320p.

The encoding parameter values of the QP value or the RF value of the respective intermediate streams 610, 620, 630, and 640 are the same as each other and the segments of the same intermediate stream may have the same resolution as each other.

The content encoding apparatuses 112 and 212 generates an encoder control signal so that the plurality of intermediate streams having the same encoding quality parameter value (or range thereof) of the QP value or RF value has the same resolution for each intermediate stream, and as a result, even though the segments of each intermediate stream are segments of intermediate streams having the same data size (bitrate), the segments may be different form each other.

That is, since each intermediate rendition is encoded while the resolution and the QP value (or the range of the QP value) are fixed, each intermediate rendition may be encoded with different data sizes (bitrates) according to image characteristics of contents of original contents. For example, in the case of a scene having many motions or a complicated scene, a segment file size increases, and in an opposite thereto, the segment file size decreases.

For example, referring to FIG. 6, each segment of the first intermediate stream 610 has the same resolution of 1080p and the same encoding quality parameter (or range of the value) of the QP value or RF value, but may be encoded into segments of the intermediate stream in which a file size of the first segment 611 is 5 Mbps, but the file size of the second segment 612 is 3 Mbps and the file size of the third segment 613 is 5 Mbps again according to the image characteristics of the contents of the original contents. More intermediate streams may be generated by the combination of the resolution and the encoding quality parameter.

In another embodiment, each segment of the intermediate streams may not accurately match a bitrate criterion of the final streams, but the bitrate of the first segment of each of the intermediate streams may be encoded into 5.1 Mbps, 2.5 Mbps, 0.8 Mbps, or 0.3 Mbps according to the image characteristics of the content data and setting of the encoding parameter, and in this case, 3 Mbps, 1 Mbps, 0.5 Mbps which are bitrate criteria of final streams having 3 different bitrates in a manifest may be controlled to be configured as range criteria of more than 1 Mbps and 3 Mbps or less, more than 0.5 Mbps and 1 Mbps OR LESS, and 0.5 Mbps or less, respectively.

Since the same content data is encoded only with different resolutions, in respect to an aspect of a change in segment file size of the intermediate stream, the second intermediate stream 620, the third intermediate stream 630, and the fourth intermediate stream 640 may also show the same aspect.

The content encoding apparatuses 112 and 212 may generate a control signal to configure a plurality of intermediate streams into a plurality of final streams illustrated in FIG. 7 (S530).

Configuring the final streams from the plurality of intermediate streams may be performed by the encoder or the control unit itself or performed by another final stream configuring unit (not illustrated) or a separate final stream configuring apparatus (not illustrated).

The content encoding apparatuses 112 and 212 may generate a control signal so as to configure segments having the same bitrate value range among the segments of each intermediate stream by the same final stream when configuring the final stream.

For example, referring to FIGS. 6 and 7, when final high/medium/low streams 710, 720, and 730 having bitrates of 3 Mbps, 1 Mbps, and 0.5 Mbps, respectively are configured from 4 intermediate streams 610, 620, 630, and 640 of FIG. 6, a first segment 711 of the final high stream 710 may be configured by the first segment 621 of the second intermediate stream 620, a second segment 721 of the final medium stream 720 may be configured by the first segment 631 of the third intermediate stream 630, and a first segment 731 of the final low stream 730 may be configured by the first segment 641 of the fourth intermediate stream 640.

Thereafter, after the second segments 612, 622, 632, and 642 of the intermediate streams 610, 620, 630, and 640 are generated, the second segments of the final streams may be configured based on the second segments of the respective intermediate streams, and this is also similar in configuring the second segments 703 of the final streams 710, 720, and 730.

In an embodiment, the content encoding apparatuses 112 and 212 may generate a control signal so as to configure the final stream based on a PSNR, SSIM, MS-SSIM, or VMAF measurement quality measured for each segment of the intermediate stream.

For example, after the content encoding apparatuses 112 and 212 receive a part corresponding to a first part of a reproduction time of original data, the content encoding apparatuses 112 and 212 may measure the quality for each segment by using a PSNR, SSIM, MS-SSIM, or VMAF measurement method after the first segments 611, 621, 631, and 641 of the respective intermediate streams 610, 620, 630, and 640 of FIG. 6 are generated.

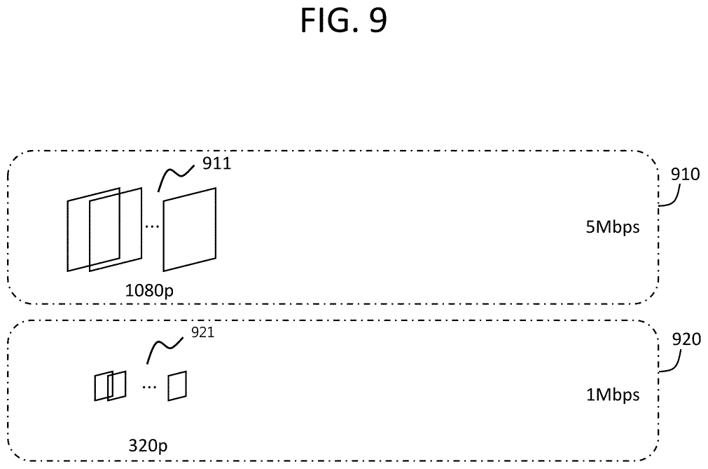

When bitrate criteria of final streams 910 and 920 having 2 different bitrates are 5 Mbps and 1 Mbps, respective in the manifest as illustrated in FIG. 9, in order to configure a first segment of the final stream 920 having the bitrate criterion of 1 Mbps, when the quality of the first segment 631 of the third intermediate stream 630 satisfying the corresponding bitrate criterion does not satisfy a criterion, the final stream 920 may be configured by the first segment 641 of the fourth intermediate stream 640, which satisfies the quality.

In another embodiment, when the intermediate stream is controlled to be encoded for each of 2 encoding quality parameters, if a segment of an intermediate stream in which any one encoding quality parameter (e.g., QP) is set to be the same does not satisfy a quality criterion and a segment of an intermediate stream in which the other encoding quality parameter (e.g., RF) is set to be the same satisfies the quality criterion, the segment of the intermediate may be controlled to be configured by the segment of the final stream.

When the content encoding apparatuses 112 and 212 generate a control signal to configure the final stream, the content encoding apparatuses 112 and 212 may generate a control signal so as to prevent reproduction orders of segments having the same bitrate value range of each intermediate stream from being overlapped, and the segments of the intermediate stream correspond to different reproduction parts of the content data. For example, respective segments 701, 702, and 703 constituting the final stream correspond to different reproduction parts of the content data, and reproduction orders of the segments are not overlapped.

The content encoding apparatuses 112 and 212 may control resolution change aspects of the segments included in each final stream of the plurality of final streams to be configured to be the same as each other.

For example, referring to FIG. 7, in respect to the respective segments of the first final stream 710, the first segment 711 has a resolution of 720p, but the second segment 712 may have a resolution of 1080p and the third segment 713 may have a resolution of 720p again, and the second final stream 720 and the third final stream 730 also have the same change aspect.

The content encoding apparatuses 112 and 212 may generate a control signal so as to configure some of the final streams after encoding content data corresponding to an entire reproduction time of the content data into a plurality of intermediate streams or after encoding all content data corresponding to a part of the reproduction time of the content data into some of the reproduction time of the content data into some of the plurality of intermediate streams. Accordingly, even when content streaming to the user terminal almost in real time is required like the live stream, the intermediate stream may be encoded substantially similarly as in reproducing an original live stream, and the final stream may be configured based thereon.

Thereafter, the content encoding apparatuses 112 and 212 may transmit, to the origin server (not illustrated), the CDN apparatus, or the user terminal, at least any one or all final streams of the plurality of generated final streams (S540).

In an embodiment, the content encoding apparatus may generate, based on a plurality of final streams including a plurality of segments having different resolutions finally generated from the content data, a manifest file including an access route capable of requesting the plurality of final streams, and the manifest file may include information regarding bitrate information for the plurality of final streams, reproduction times of contents, an access route (URL, etc.), an encoding type, a resolution of a segment, etc.

In an embodiment, the content encoding apparatus may periodically generate the manifest file, and the manifest file may be related to each segment of the generated final stream.

For example, after a first manifest file including information on bitrate information of the first segment 711 of the final high stream 710, the reproduction time of the contents, the access route (URL, etc.), the encoding type, the resolution of the segment, etc., is generated, a second manifest file including information on the second segment 712 may be similarly generated.

The manifest file may indicate a manifest file of each final stream, and the manifest file of each final stream may include a segment access route of each rendition, a reproduction time of the segment, the encoding type, the resolution of the segment, etc.

In an embodiment, the content encoding apparatus may package each final stream in HTTP Live Streaming (HLS), Dynamic Adaptive Streaming over HTTP (DASH), and Microsoft Smooth Streaming (MSS) formats.

In an embodiment, the content encoding apparatus may make the manifest file or segment include an encoding parameter of the segment. When the segment includes the encoding parameter, the final stream may be controlled to be generated, which includes a separate segment header for each segment so as to be distinguished from encoded data.

Since the encoding parameter such as the resolution, etc., is the same for each segment in the same intermediate stream as illustrated in FIG. 6, but the encoding parameter such as the resolution may be different for each segment in spite of the same final stream as illustrated in FIG. 7, the encoding parameter is included in the manifest file or the segment header and when the user terminal receives and reproduces the encoding parameter, if the received and reproduced encoding parameter is different from an encoding parameter of a segment which is used just previously, a transmitted segment may be decoded and reproduced after performing codec initialization of the user terminal. Accordingly, even when the encoding parameter such as the resolution, etc., is different for each segment of the final stream transmitted to the user terminal, the user terminal may successively reproduce the final stream.

That is, according to the embodiment, even when the same final stream (the same rendition) is continuously transmitted, there is an effect that the encoding parameter is changed similarly to a case of changing the final stream (receiving another rendition) in the related art.

Term “unit” or “module” used in the present disclosure may mean, for example, a unit including one or two or more combinations of hardware, software, or firmware. The “unit” or “module” may be used interchangeably with a term such as unit, logic, logical block, component, or circuit, for example. The “unit” or “module” may become a minimum unit of an integrally configured component or a part thereof. The “unit” or “module” may also become a minimum unit performing one or more functions or a part thereof. The “unit” or “module” may be mechanically or electronically implemented. For example, the “unit” or “module” may include at least one of an application-specific integrated circuit (ASIC) chip, field-programmable gate arrays (FPGAs), or a programmable-logic device performing any operations, which is known or to be developed.

At least some of apparatuses (e.g., modules or functions thereof) or methods (e.g., operations) according to various embodiments may be implemented as instructions stored computer-readable storage media in a form of a program module. When the instruction is executed by a processor (e.g., the processor), the one or more processes may perform a function corresponding to the instruction. The computer-readable storage media may be, for example, the memory.

Computer-readable recording media may include a hard disk, a floppy disk, magnetic media (e.g., magnetic tape), optical media (e.g., compact disc read only memory (CD-ROM), digital versatile disc, magneto-optical media (e.g., a floptical disk)), hardware devices (e.g., read only memory (ROM), random access memory (RAM), or flash memory), etc. Further, a program command may include a high-level language code executable by a computer by using an interpreter and the like, as well as a machine language code created by a compiler. The hardware device may be configured to be operated with one or more software modules in order to perform the operations of various embodiments and vice versa.

The module or program module according to various embodiments may include at least one of the above-described components or some components may be omitted, or the module or program module may further include additional other components. Operations performed by the module, the program module, or other components according to various embodiments may be executed in a sequential, parallel, repeated, or heuristic method. Further, some operations may be executed in another order or omitted, or other operations may be added.

Hereinabove, a preferred embodiment for the technology of the present disclosure is described with reference to the accompanying drawings. Here, terms or words used in the present disclosure and the claims should not be construed only as conventional or dictionary meanings, and should be construed as meanings and concepts that conform to the technical spirit of the present disclosure.

The scope of the present disclosure is not limited to the embodiments disclosed in the present disclosure, and the present disclosure may be modified, changed, or improved to various forms within the spirit of the present disclosure and a category disclosed in the claims.

What is claimed is:

1. An encoding method of an encoding apparatus, which is performed by a computing device, the method comprising:
generating an encoder control signal to encode video contents into a plurality of intermediate streams having different resolutions and having a range of the same encoding quality parameter value; and
generating a control signal to configure a plurality of final streams based on segments of each intermediate stream, which have a range of the same bitrate value,
wherein the intermediate stream and the final steam include at least one segment.

2. The encoding method of an encoding apparatus of claim 1, wherein the generating of the plurality of final streams includes
configuring the segments of each intermediate stream, which have the range of the same bitrate value by the same final stream while reproduction orders are not overlapped with each other, and
wherein parts of the video contents corresponding to a plurality of segments of any one final stream of the plurality of final streams are different from each other.

3. The encoding method of an encoding apparatus of claim 1, wherein the generating of the encoder control signal to encode into the plurality of intermediate streams includes indicating the number of plurality of intermediate streams to be generated to equal to or more than the number of plurality of final streams, and
the generating of the control signal to configure the plurality of final streams includes performing segment quality measurement of the plurality of intermediate streams, and
generating a control signal to configure the plurality of final streams based on a result of the segment quality measurement.

4. The encoding method of an encoding apparatus of claim 1, wherein in the plurality of intermediate streams, segments of different intermediate streams have different resolutions and segments of the same intermediate stream have the same resolution, and
any one final stream of the plurality of final streams includes segments having different resolutions.

5. The encoding method of an encoding apparatus of claim 1, comprising:
generating a first manifest file and a second manifest file based on different segments of any one final stream of the plurality of final streams, respectively, and
segment resolution information included in the first manifest file is different from segment resolution information included in the second manifest file.

6. The encoding method of an encoding apparatus of claim 1, wherein bitrate change aspects of the segments included in each intermediate stream of the plurality of intermediate streams are the same as each other or resolution change aspects of the segments included in each final stream of the plurality of final streams are the same as each other.

7. The encoding method of an encoding apparatus of claim 3, wherein the generating of the control signal to configure the plurality of final streams based on the result of the segment quality measurement is generating a control signal to configure the plurality of final streams based on a segment of an intermediate stream suitable for a bitrate criterion of each final stream and a preset quality measurement criterion.

8. An encoding apparatus comprising:
a storage unit storing at least any one of video contents, a control variable for generating an encoder control signal, and intermediate data generated during an encoding process;
a control unit generating an encoder control signal to encode the video contents into a plurality of intermediate streams having different resolutions and a range of the same encoding quality parameter value, and generating a control signal to configure a plurality of final streams based on segments of each intermediate stream, which have a range of the same bitrate value; and
a communication unit receiving the video contents or transmitting at least any one final stream of the final streams,
wherein the intermediate stream and the final steam include at least one segment.

9. The encoding method of an encoding apparatus of claim 8, wherein parts of the video contents corresponding to a plurality of segments of any one final stream of the plurality of final streams are different from each other and any one final stream of the plurality of final streams includes segments having different resolutions.

10. A computer device-readable medium having a program for executing operations, which is recorded therein and the operations comprise:
generating an encoder control signal to encode video contents into, as a plurality of intermediate streams having different resolutions and having a range of the same encoding quality parameter value, the plurality of intermediate streams including at least one segment; and
generating a control signal to configure, as a plurality of final streams including at least one segment, the plurality of final streams based on one or more segments of each intermediate stream, which have a range of the same bitrate value.
